(19) United States
(12) Patent Application Publication
(10) Pub. No.: US 2023/0374316 A1
(43) Pub. Date: Nov. 23, 2023

(54) Antimicrobial coating

(71) Applicant: Nanostratus Pty LTD, North Warrandyte (AU)

(72) Inventors: Antonio Tricoli, Canberra (AU); David Nisbet, Canberra (AU); Deepu Ashok, Canberra (AU); Mahdiar Taheri, Canberra (AU)

(73) Assignee: Nanostratus Pty LTD, North Warrandyte (AU)

(21) Appl. No.: 18/019,811

(22) PCT Filed: Aug. 6, 2021
(86) PCT No.: PCT/AU2021/050860

§ 371 Date: Feb. 5, 2023

(30) Foreign Application Priority Data
Aug. 6, 2020 (AU) 2020902767

(51) Int. Cl. C09D 5/14; C09D 175/04; C09D 133/08; C08K 3/36; C08K 9/04; C08K 5/56; B05D 1/02; C09D 7/62

(52) U.S. Cl. CPC C09D 5/14; C09D 175/04; C09D 133/08; C08K 3/36; C08K 9/04; C08K 5/56; B05D 1/02; C09D 7/62; C08K 2201/005; C08K 2201/011; B05D 2503/00; B05D 2502/00

(57) ABSTRACT

This invention relates to an antimicrobial coating comprising: a polyurethane and a polyacrylate in an interpenetrating polymer network; a hydrophobic particulate solid; and a metal-containing particulate solid, as well as to a method for rendering a surface hydrophobic and antimicrobial, a method for making an antimicrobial coating, and the use of an antimicrobial coating.

### RELATED APPLICATIONS

This application claims priority from Australian Patent Application No. 2020902767 filed on 6 Aug. 2020, the entire contents of which are incorporated herein by reference.

### FIELD

The invention relates to superhydrophobic and antimicrobial coatings.

### BACKGROUND

Contamination of public surfaces and resultant infections are significant public health issues, as seen recently with the rise of COVID-19 and the global fight to stop superbugs. In the latter, the situation is becoming significantly adverse in the wake of bacterial strains developing resistance to antibiotics. Significant effort is being directed at exploring novel antibiotic-free methods to tackle bacterial pathogens, including the development of self-cleaning surfaces that can be deployed in a range of settings, such as surgical suites and medical facilities, bathrooms and food preparation areas.

Superhydrophobic coatings have been previously demonstrated for resisting biofilm formation and hence bacteria propagation. If bacteria can be prevented from attaching to a surface, a biofilm will not form on that surface. Superhydrophobicity is a surface property commonly found in nature where water forms a droplet on it (with static water contact angles >150°) and moreover, if the droplet slides off from the surface easily (i.e. with a contact angle hysteresis of <10°), it carries away any dirt or contaminants on the surface, resulting in self-cleaning. The extreme water repellent characteristic of a surface is attributed to a combination of high roughness (on both micro- and nano-scales) and non-wetting surface chemistry, the classic example being a lotus leaf. Accordingly, when a bacterial source in droplet form contacts a superhydrophobic surface, it forms droplets on the surface that can be removed by gentle washing.

When a superhydrophobic surface is submerged or substantially covered in water, a Cassie-Baxter state forms at the superhydrophobic surface, whereby a thin air-film (called a plastron) forms between the solid surface and liquid, preventing the liquid from wetting the solid. This plastron acts as an effective barrier between the water and the superhydrophobic surface, separating any bacteria in the water from the superhydrophobic surface and hence preventing adhesion of bacteria and subsequent formation of biofilms. However, plastrons are known to collapse under the pressure of the water above a superhydrophobic surface during extended periods of water submersion, resulting in wetting of the surface. In situations where the superhydrophobic surface is immersed in a bacteria-containing water source, or bacteria are present on the dry surface which subsequently becomes wetted, this can result in adhesion of bacteria and hence formation of biofilms, disrupting the self-cleaning ability of the superhydrophobic surface. Whilst one approach to increasing the antimicrobial resistance of a superhydrophobic surface may be to extend the duration of the plastron before bursting, this is still ultimately defined by physical processes and will be affected by, for instance, the temperature of the water, and/or the depth of submersion, and hence weight of the water, on the plastron. Accordingly, there is a need for a superhydrophobic surface that can maintain microbial resistance even when wetted.

### SUMMARY OF INVENTION

In a first aspect of the present invention, there is provided an antimicrobial coating comprising: a polyurethane and a polyacrylate in an interpenetrating polymer network; a hydrophobic particulate solid; and a metal-containing particulate solid.

The following options may be used in conjunction with the first aspect, either individually or in any suitable combination.

The metal-containing particulate solid may comprise at least one metal selected from the group consisting of zinc, copper, silver, cobalt, nickel, gold, zirconium, magnesium and molybdenum, or it may comprise a metal organic framework, or it may comprise a metal oxide, or it may comprise a combination of any of these. When the metal-containing particulate solid comprises a metal organic framework, the metal organic framework may be ZIF-8, ZIF-67, UiO-66, Ag-BTC, PCMOF10, Cu-MOF-14 or Cu-MOF-891 or a combination thereof. The metal-containing particulate solid may comprise or consist of the metal organic framework ZIF-8.

The hydrophobic particulate solid may be a hydrophobic fumed silica. It may be perfluoroalkyl-functionalised particles. The perfluoroalkyl-functionalised particles may be functionalised hydrophobic fumed silica (i.e., fluorosilica) or it may be any other suitable particulate solid capable of being functionalised with perfluoroalkyl groups.

The hydrophobic particulate solid may have a mean particle size of between 1 nm and 20 nm in diameter, e.g., about 1, 2, 3, 4, 5, 6, 7, 8, 9, 10, 11, 12, 13, 14, 15, 16, 17, 18, 19 or 20 nm. The metal-containing particulate solid may have a mean particle size of between 1 nm and 400 nm in diameter, e.g. about 1, 2, 3, 4, 5, 6, 7, 8, 9, 10, 15, 20, 25, 30, 40, 50, 60, 70, 80, 90, 100, 150, 200, 250, 300, 350 or 400 nm. They may both have the same mean particle size or they may have different mean particle sizes. The hydrophobic particulate solid and/or the metal-containing particulate solid may be at least partially embedded in the antimicrobial coating, or it may be fully embedded in the coating. The percentage by mass of the metal-containing particulate solid compared to the hydrophobic particulate solid may be between about 5% and about 20%, e.g., about 5, 6, 7, 8, 9, 10, 11, 12, 13, 14, 15, 16, 17, 18, 19 or 20%.

The antimicrobial coating may be superhydrophobic. The antimicrobial coating may have a water contact angle greater than 150°, e.g., it may be about 150°, or about 155°, 160°, 165°, 170° or about 175°. The antimicrobial coating may have a rolling angle of less than about 10°, e.g., it may be about 10°, 9°, 8°, 7°, 6°, 5°, 4°, 3°, 2°, 1° or 0°. The rolling angle may be about 0°. The water contact angle may be reduced and/or rolling angle may be increased by no more than 5% (e.g., reduced by about 1%, 2%, 3%, 4% or 5%) after at least 100 abrasion cycles performed according to ASTM D4060-14.

The antimicrobial coating may resist bacterial adhesion. It may resist bacterial adherence for at least 9 days when in contact with a 104-105 CFU/ml bacterial suspension.

When in contact with an aqueous environment, a plastron may be formed on a surface of the coating. The plastron may be maintained for at least 8 hours or more, when at temperatures between 20° C. and 37° C. The plastron may be maintained when the coating is submerged and at a depth of up to about 5 cms (e.g., at a depth of about 1, 2, 3, 4, or 5 cms).

In one embodiment there is provided an antimicrobial coating comprising: a polyurethane and a polyacrylate in an interpenetrating polymer network; a hydrophobic particulate solid; and a metal-containing particulate solid which comprises the zinc-containing metal organic framework ZIF-8, whereby the hydrophobic particulate solid has a mean particle size of between 1 nm and 20 nm in diameter and the metal-containing particulate solid has a mean particle size of between 1 nm and 400 nm and are both at least partially embedded in a surface of the coating.

In another embodiment there is provided an antimicrobial coating comprising: a polyurethane and a polyacrylate in an interpenetrating polymer network; particles of a hydrophobic fumed silica; and a metal-containing particulate solid comprising at least one metal selected from zinc, copper, silver, cobalt, nickel, gold, zirconium, magnesium and molybdenum, wherein the hydrophobic particulate solid and the metal-containing particulate solid both have a mean particle size of between 5 nm and 20 nm in diameter and are both at least partially embedded in a surface of the coating.

In another embodiment there is provided an antimicrobial coating comprising: a polyurethane and a polyacrylate in an interpenetrating polymer network; particles of fluorosilica with a mean particle size of between 5 nm and 10 nm in diameter; and particles consisting of the zinc-containing metal organic framework ZIF-8 with a mean particle size of between 1 nm and 400 nm in diameter; whereby the percentage by mass of particles consisting of the zinc-containing metal organic framework ZIF-8 to particles of fluorosilica are between 5% and 15%, and are both at least partially embedded in a surface of the coating. The coating of this embodiment has a water contact angle greater than 150° and a rolling angle of about 0°, which is varied by no more than 5% after at least 100 abrasion cycles performed according to ASTM D4060-14, resists bacterial adherence for at least 9 days when in contact with a 104-105 CFU/ml bacterial suspensions, and when in contact with an aqueous environment, a plastron is formed on a surface of the coating and is maintained for at least 8 hours at temperatures between 20° C. and 37° C. and at a depth of up to 5 cms.

In a second aspect of the present invention, there is provided a method for rendering a surface hydrophobic and antimicrobial, comprising forming a coating according to the first aspect on the surface.

In a third aspect of the present invention, there is provided a method for making an antimicrobial coating, comprising the steps of: (a) applying a colloidal suspension to a surface to produce a coated surface, wherein the colloidal suspension comprises colloidal particles suspended in an organic solvent, and wherein the colloidal particles comprise an interpenetrating polymer network, wherein the interpenetrating polymer network consists of a polyurethane and a polyacrylate; (b) applying a hydrophobic particulate solid to the coated surface; and (c) applying a metal-containing particulate solid to the coated surface.

The following options may be used in conjunction with the third aspect, either individually or in any suitable combination.

Steps (b) and (c) may be carried out simultaneously by applying a mixture comprising the hydrophobic particulate solid and the metal-containing particulate solid to the coated surface. When mixed, the hydrophobic particulate solid and the metal-containing particulate solid may be homogeneously mixed before simultaneously applying to the coated surface.

The method of the third aspect may further comprise a step of suspending a metal-containing particulate solid in the colloidal suspension prior to step (a). The metal-containing particulate solid suspended in the colloidal suspension may be the same as the metal-containing particulate solid applied in step (c) or it may be different.

In a fourth aspect of the present invention, there is provided a method for making an antimicrobial coating, comprising the steps of: (a) applying a suspension mixture to a surface to produce a coated surface, the mixture comprising: (i) a colloidal suspension, wherein the colloidal suspension comprises colloidal particles, and wherein the colloidal particles comprise an interpenetrating polymer network, wherein the interpenetrating polymer network consists of a polyurethane and a polyacrylate; and (ii) a metal-containing particulate solid; wherein the colloidal suspension and the metal-containing particulate solid are suspended in an organic solvent; and (b) applying a hydrophobic particulate solid to the coated surface.

The following options may be used in conjunction with the third aspect or the fourth aspect, either individually or in any suitable combination.

The applying of step (a) may be carried out by dipcoating, spincoating, dropcasting, electrospinning or spraying. The applying of step (b) and step (c) may be carried out by spraying.

The metal-containing particulate solid may comprise at least one metal selected from the group consisting of zinc, copper, silver, cobalt, nickel, gold, zirconium, magnesium and molybdenum, or it may comprise a metal organic framework, or it may comprise a metal oxide, or it may comprise a combination of any of these. When the metal-containing particulate solid comprises a metal organic framework, the metal organic framework may be ZIF-8, ZIF-67 UiO-66, Ag-BTC, PCMOF10, Cu-MOF-14 or Cu-MOF-891 or a combination thereof. The metal-containing particulate solid may comprise or consist of the zinc-containing metal organic framework ZIF-8.

The hydrophobic particulate solid may be a hydrophobic fumed silica. It may be functionalised across substantially the entire surface with hydrophobic organic groups. It may be perfluoroalkyl-functionalised particles. The perfluoroalkyl-functionalised particles may be functionalised hydrophobic fumed silica (i.e., fluorosilica) or it may be any other suitable particulate solid capable of being functionalised with perfluoroalkyl groups.

The hydrophobic particulate solid may have a mean particle size of between 1 nm and 20 nm in diameter, e.g., about 2, 3, 4, 5, 6, 7, 8, 9, 10, 11, 12, 13, 14, 15, 16, 17, 18, 19 or 20 nm. The metal-containing particulate solid may have a mean particle size of between 1 nm and 400 nm in diameter, e.g. about 1, 2, 3, 4, 5, 6, 7, 8, 9, 10, 15, 20, 25, 30, 40, 50, 60, 70, 80, 90, 100, 150, 200, 250, 300, 350 or 400 nm. They may both have the same mean particle size or they may have different mean particle sizes. The percentage by mass of the metal-containing particulate solid compared to the hydrophobic particulate solid in the coating may be between about 5% and about 20%, such as between about 5% and about 15%.

The hydrophobic particulate solid and/or the metal-containing particulate solid may be suspended in an organic solvent prior to applying to the coated surface. The organic solvent may be acetone.

The surface may consist of plastic, concrete, glass, ceramic, paper, brick, wood or a mixture thereof, or any other suitable material to which the coating adheres.

In one embodiment there is provided a method for making an antimicrobial coating, comprising the steps of: (a) applying a colloidal suspension to a surface to produce a coated surface, the colloidal suspension comprising colloidal particles of an interpenetrating polymer network consisting of a polyurethane and a polyacrylate suspended in acetone; (b) applying a hydrophobic particulate solid to the coated surface; and (c) applying particles consisting of the zinc-containing metal organic framework ZIF-8 to the coated surface.

In another embodiment there is provided a method for making an antimicrobial coating, comprising the steps of: (a) applying a colloidal suspension to a surface to produce a coated surface, the colloidal suspension comprising colloidal particles of an interpenetrating polymer network consisting of a polyurethane and a polyacrylate suspended in acetone; (b) applying particles of a hydrophobic fumed silica of between 5 nm and 10 nm average mean diameter to the coated surface; and (c) applying a metal-containing particulate solid of between 5 nm and 10 nm average mean diameter to the coated surface, wherein the metal may consist of at least one of zinc, copper, silver, cobalt, nickel, gold, zirconium, magnesium and molybdenum.

In yet another embodiment there is provided a method for making an antimicrobial coating, comprising the steps of: (a) applying a colloidal suspension by spraying to a surface to produce a coated surface, the colloidal suspension comprising colloidal particles of an interpenetrating polymer network consisting of a polyurethane and a polyacrylate suspended in acetone; (b) applying an homogenous mixture of fluorosilica particles of between 5 nm and 10 nm average mean diameter to the coated surface, and particles of the zinc-containing metal organic framework ZIF-8 of between 5 nm and 10 nm average mean diameter to the coated surface by spraying, wherein the percentage mass of particles of the zinc-containing metal organic framework ZIF-8 compared to the mass of the fluorosilica is between 5% and 15%.

In a further embodiment there is provided a method for making an antimicrobial coating, comprising the steps of: (a) applying a suspension mixture to a surface to produce a coated surface, the mixture comprising: (i) a colloidal suspension, wherein the colloidal suspension comprises colloidal particles comprising an interpenetrating polymer network which consists of a polyurethane and a polyacrylate; and (ii) a metal-containing particulate solid comprising at least one metal selected from zinc, copper, silver, cobalt, nickel, gold, zirconium, magnesium and molybdenum; wherein the colloidal suspension and the metal-containing particulate solid are suspended in acetone; and (b) applying particles of fluorosilica to the coated surface.

In yet another embodiment there is provided a method for making an antimicrobial coating, comprising the steps of: (a) applying a suspension mixture to a surface to produce a coated surface, the mixture comprising: (i) a colloidal suspension, wherein the colloidal suspension comprises colloidal particles comprising an interpenetrating polymer network which consists of a polyurethane and a polyacrylate; and (ii) particles consisting of a metal organic framework; wherein the colloidal suspension and the particles consisting of the zinc-containing metal organic framework ZIF-8 are suspended in acetone; and (b) applying a hydrophobic particulate solid to the coated surface.

In another embodiment there is provided a method for making an antimicrobial coating, comprising the steps of: (a) applying a suspension mixture to a surface by spraying to produce a coated surface, the mixture comprising: (i) a colloidal suspension, wherein the colloidal suspension comprises colloidal particles comprising an interpenetrating polymer network which consists of a polyurethane and a polyacrylate; and (ii) particles consisting of the zinc-containing metal organic framework ZIF-8 of between 5 nm and 10 nm average mean diameter; wherein the colloidal suspension and the particles consisting of the zinc-containing metal organic framework ZIF-8 are suspended in acetone; and (b) applying fluorosilica particles of between 5 nm and 10 nm average mean diameter to the coated surface by spraying, wherein the percentage mass of particles of the zinc-containing metal organic framework ZIF-8 compared to the mass of the fluorosilica is between 5% and 15%.

In a fifth aspect of the present invention, there is provided a coating produced by conducting the method of the third or fourth aspects and allowing the resulting coating to cure.

In a sixth aspect of the present invention, there is provided a use of a coating according to any one of the first, second or third aspects, or a coating produced by conducting the method of the fourth or fifth aspects and allowing the resulting coating to cure, as a protective coating on a surface.

In a seventh aspect of the present invention, there is provided a use of a coating according to any one of the first, second or third aspects, or a coating produced by conducting the method of any one of the fourth or fifth aspects and allowing the resulting coating to cure, to render a surface superhydrophobic and antimicrobial

### BRIEF DESCRIPTION OF DRAWINGS

FIG. 1: (a)-(c) A schematic representation of the mechanism of superhydrophobic surfaces exposed to a bacterial suspension; (d) image of bacterial distribution on uncoated steel; (e) image of bacterial distribution on SHS coated steel; (f)-(h) images at specific time points for bare steel in contact with a bacterial suspension; (i) velocity profile of bacteria in contact with bare steel surface; (j)-(l) images at specific time points for coated steel in contact with a bacterial suspension; (m) velocity profile of bacteria in contact with coated steel surface.

FIG. 2: (a)-(d) Axio-observer images of the agar imprints of control-steel and SHS showing qualitatively the relative extent of adhesion under unwashed and washing conditions; (e) plot showing the serial dilution data.

FIG. 3: (a) Orthogonal projection of the coating-defect interface with bacteria on it; (b) velocity profiles of bacteria on regions A, B and C.

FIG. 4: (a-h) Axio-observer images of the agar plate imprints corresponding to SHS incubated with bacteria for 1 hour to 8 h respectively; (i) Serial dilution data of the long exposure experiment.

FIG. 5: (a) XRD pattern and (b) FTIR spectra of the coatings containing 5-15% ZIF-8 powders on stainless steel in comparison with ZIF-8 powders alone; (c) EDX elemental mapping of a 15% ZIF-8 containing coating showing the distribution (L-R) of oxygen, silicon and zinc elements.

FIG. 6: Plot showing the serial dilution data of the samples containing ZIF-8 powders after 1, 5, and 9 days.

### DEFINITIONS

The following abbreviations are used in the present specification:
CFU: colony-forming unit
EPS: extracellular polymeric substances
IPN: interpenetrating polymer network
MOF: Metal organic framework
PMMA: polymethyl methacrylate
PU: polyurethane
ROS: Reactive oxygen species
SHS: superhydrophobic surface
ZIF: zeolitic imidazolate framework

The following terms are used in the present specification which are defined as set out below:

Antimicrobial: a substance that is active against microbes, leading to either (or both) elimination of the microbes (leading to negative growth over time and a reduction in microbial cell numbers), or repression of the reproduction of microbes (leading to constant growth over time and no change in microbial cell numbers). If the substance is only active against bacteria, this term may be replaced with “antibacterial”.

IPN: a polymer comprising two (or more) networks that are at least partially interlaced on a molecular scale but not covalently bonded to each other and cannot be separated unless chemical bonds are broken;

Microbe: a microorganism causing disease or fermentation. May include bacteria, viruses, fungi, algae, archaea or protozoa.

MOF: a crystalline coordination network consisting of metal ions or clusters coordinated to organic ligands to form one-, two- or three-dimensional structures, often containing voids or pores. Similar in structure to zeolite minerals.

Plastron: a thin layer of air formed between a superhydrophobic surface and a hydrophilic liquid (preferably water) in a Cassie-Baxter state;

Polyacrylate: a polymer formed from monomers comprising a C═C—C═O structure (acrylic monomers);

Polyurethane: a polymer formed from organic units joined by carbamate (urethane) links of a —NH—(C═O)—O— structure;

Superhydrophobic: a material surface with a water contact angle of at least 150°.

The following definitions are provided to enable the skilled person to better understand the invention disclosed herein. These are intended to be general and are not intended to limit the scope of the invention to these terms or definitions alone.

As used herein, the term “comprising” means “including”. Variations of the word “comprising”, such as “comprise” and “comprises”, have correspondingly varied meanings. As used herein, the terms “including” and “comprising” are non-exclusive. As used herein, the terms “including” and “comprising” do not imply that the specified integer(s) represent a major part of the whole.

As used herein, the term “consisting essentially of” means “to the exclusion of other additional components purposefully added”, or “only the following recited elements are intended to be present”. Additional components that are in the defined composition or device that are not intentionally present are acceptable.

### DESCRIPTION OF EMBODIMENTS

The present invention described herein relates to an antimicrobial coating and a method for making the coating. More specifically, the present invention relates to a dual-functional coating which can resist bacterial adhesion and biofilm formulation in both dry and wet conditions. The dual functionality of the coating is provided by (a) a superhydrophobic surface, which resists bacterial colonization when dry or when the interfacial liquid is in a Cassie-Baxter state (separated from the superhydrophobic surface by a plastron), and (b) a non-antibiotic antimicrobial particle that is at least partially embedded in the surface for bacterial resistance when the superhydrophobic surface is wetted and bacteria can directly access the surface.

The inventors have previously described a colloidal suspension which, when applied to a surface as a coating, renders that surface superhydrophobic (WO 2017/193157 A1, herein incorporated in its entirety by reference). It is envisioned that the same processes and materials may be used and applied to produce the dual-functional coatings of the present invention.

### Coating

The antimicrobial coating of the present invention comprises an IPN layer applied to a surface upon which the coating is to be applied. It is understood that the cured IPN layer provides the surface with micro-scale roughness as well as durability and resistance to abrasion. In a preferred embodiment, the IPN comprises, or contains, or essentially contains a polyurethane polymer system and a polyacrylate or polymethacrylate polymer system.

The monomers used to form the polyacrylate or polymethacrylate system may be any suitable acrylic or methacrylic monomer. It may be for instance a (meth)acrylic ester, a (meth)acrylamide, (meth)acrylic acid or some other monomer (e.g. an alkoxymethacrylic ester). In the case of an ester, it may be an ester of a diol, a triol, a tetraol, a pentaol or some other polyol, i.e. it may be a diester, triester, tetraester or pentaester etc. In the case of an amide, it may have structure HN((═O)C—CH═CH₂), N((═O)C—CH═CH₂)₃ or some other similar structure. The polyacrylate or polymethacrylate system may be crosslinked. The crosslinking monomer may similarly be a (meth)acrylic ester or a (meth)acrylamide.

The monomers used to from the polyurethane polymer system may be any suitable monomer based on urethane chemistry. i.e., it contains a diol, a polyol and an isocyanate having at least two isocyanate groups per molecule. The isocyanate may for example be TDI (toluene diisocyanate, e.g. 2,4 or 2,6 or a mixture thereof), MDI (methylene diphenyldiisocyanate), IPDI (isophorone diisocyanate), HDI (hexamethylene diisocyanate), HMDI (hydrogenated MDI: methylene bis(4-cyclohexylisocyanate)), naphthalene diisocyanate, triphenylmethane-4,4′,4″-triyl triisocyanate or some other diisocyanate or triisocyanate. It may be an aromatic isocyanate or may be an aliphatic diisocyanate. In some instances the isocyanate may have more than 2 isocyanate groups per molecule, e.g. 3, 4 or 5. The diol may be any suitable compound having two hydroxyl groups joined by an organic moiety. It may be an alkane diol (i.e. the organic moiety may be an alkanediyl group, which may be straight chain, branched, cyclic or may have two or all of these structures), for example an alkane a,w-diol in which the alkane is a straight chain alkane (i.e. it may be HO(CH₂)ₙOH), in which case n may be from 2 to 12, or 2 to 10, 2 to 6, 3 to 8 or 4 to 6, e.g. 2, 3, 4, 5, 6, 7, 8, 9, 10, 11 or 12, optionally greater than 12), or it may be a polyether polyether diol (e.g. HO(CH₂CH₂O)ₙH or HO(CH(CH₃)CH₂O)ₙH, in which case n may be from 1 to about 50, or about 1 to 20, a to 10, 1 to 5, 5 to 50, 10 to 50, 20 to 50, 5 to 20, 5 to 10 or 10 to 20, e.g. 1, 2, 3, 4, 5, 6, 7, 8, 9, 10, 15, 20, 25, 30, 35, 40, 45 or 50, optionally greater than 50) or it may be some other type of diol. The diol may have a molecular weight of between about 500 and about 5000, or 1000 to 5000, 2000 to 5000, 500 to 2000, 500 to 1000 or 1000 to 2000, e.g. about 500, 1000, 1500, 2000, 2500, 3000, 3500, 4000, 4500 or 5000. It may have no other functional group other than OH. It may have no amine groups. It may have no carboxyl groups. It may have no carbon-carbon unsaturation (i.e. no double bonds or triple bonds). It may have no groups that would be polymerisable using free radical initiation. The polyol is any suitable compound containing more than two hydroxyl groups per molecule. It may have 3, 4, 5, 6, 10, 15, 20 or more than 20 hydroxyl groups per molecule. It may be a monomeric polyol or it may be oligomeric. It may be for example a saccharide, tris(hydroxymethyl)propane, tris(hydroxymethyl)ethane, pentaerythritol, erythritol or some other type of polyol. It may be an aliphatic polyol. It may have no carbon-carbon unsaturation (i.e. no double bonds or triple bonds). It may have no groups that would be polymerisable using free radical initiation. It may have no other functional group other than OH. It may have no amine groups. It may have no carboxyl groups. It may be monomeric.

The antimicrobial coating of the present invention also comprises a hydrophobic particulate solid. Without being bound to theory, it is understood that the hydrophobic particulate solid provides nano-scale roughness and hydrophobic chemistry to the coating when it is embedded or at least partially embedded in the surface of the IPN layer. The hydrophobic particulate solid is particulate, and it may have a mean particle size of about 1 to about 20 nm, or about 2 to 10, 2 to 5, 5 to 20, 10 to 20 or 5 to 20, e.g., about 2, 3, 4, 5, 6, 7, 8, 9, 10, 11, 12, 13, 14, 15, 16, 17, 18, 19 or 20 nm.

The hydrophobic particulate solid may be an inorganic particulate solid. Particles of the hydrophobic particulate solid may have organic regions and inorganic regions. The inorganic particles or regions may comprise silicon, or they may comprise metal elements that are not antimicrobial in nature (i.e., they may comprise any metal that is not zinc, copper, silver, cobalt, nickel, gold, zirconium, magnesium and molybdenum). For example, they may comprise iron or titanium. They may be a ceramic. They may be iron oxide. They may be titania. They may be a hydrophobic ceramic, e.g., a hydrophobic silica. They may be a fumed silica, e.g., a hydrophobic fumed silica. The organic regions may be on the surface of the particles. For example, they may be silica having grafted organic groups on the surface. The grafted organic groups are hydrophobic. The hydrophobic organic groups may be alkyl groups, e.g. C1 to C8 straight chain or branched alkyl groups, such as methyl, ethyl, n-propyl, i-propyl, n-butyl, t-butyl, hexyl, octyl, isooctyl, decyl, dodecyl, tetradecyl or hexadecyl. They may be fluoroalkyl groups, e.g. perfluoalkyl groups. They may be fluorinated or perfluorinated or partially perfluorinated forms of any of the alkyl groups described above. Any two or more of the above hydrophobic groups may be present. For example, the fumed silica may have fluoroalkyldialkylsilyloxy groups on the surface. The alkyl groups may be any of the alkyl groups described above, and the fluoroalkyl group may be any of the fluoroalkyl groups described above. For example the particulate solid may comprise fumed silica having 1H,1H,2H,2H-perfluorooctyldimethylsiloxy groups on the surface thereof. It should be noted that “1H,1H,2H,2H-perfluorooctyl” refers to F₃C(CF₂)₅(CH₂)₂—. Mixtures of two or more of these particles may be used. As used herein, “fluorosilica” refers to particles of hydrophobic fumed silica functionalised with at least one fluoroalkyl group.

The antimicrobial coating of the present invention also comprises a metal-containing particulate solid. Without being bound to theory, it is understood that the metal-containing particulate solid provides antimicrobial or antibacterial activity when the surface is wetted. The metal-containing particles may contain or comprise a metal that has an antimicrobial or antibacterial effect, e.g. the metal may be selected from the group consisting of zinc, copper, silver, cobalt, nickel, gold, zirconium, magnesium and molybdenum. They may be crystalline. They may be metallic particles, e.g., they may contain or comprise solid metal. The metallic particles may comprise a single metal or they may be an alloy. They may comprise a metal organic framework (MOF). They may be nano-scale crystals of MOF. Any MOF comprising a metal with antimicrobial or antibacterial activity may be suitable. For example, the MOF may be ZIF-8 (comprising zinc, and/or cobalt, and/or copper ions, and/or magnesium and 2-methylimidazole ligands), ZIF-67 (comprising zinc, and/or cobalt, and/or copper, and/or magnesium ions and 2-methylimidazole ligands, isostructural to ZIF-8), UiO-66 (a zirconium-based MOF comprising [Zr₆O₄(OH)₄] clusters and 1,4-benzene dicarboxylic acid), Ag-BTC (comprising Ag⁺ ions and benzene tricarboxylic acid ligands), PCMOF10 (a magnesium-based 2-D layered MOF comprising hydrated [Mg(H₂O)₄(2,5-dicarboxy-1,4-benzene-diphosphonic acid)]), Cu-MOF-14 (comprising Cu²⁺ ions and 1,3,5-tris(4-carboxyphenyl)benzene ligands) or Cu-MOF-891 (comprising Cu²⁺ ions and 1′,2′,3′,4′,5′,6′-hexakis(4-carboxyphenyl)benzene ligands), or any other MOF comprising an antimicrobial metal and organic ligand formed through hydrothermal or solvothermal crystallisation. The MOFs may comprise a single metal ion species or they may be doped with one or more metal ion species. The metal-containing particulate solid may be amorphous. They may comprise metal-containing regions and organic regions, i.e., they may comprise metal ion complexes, whereby the ligands are any suitable metal chelator or chelators, the selection of which may be influenced by the charge and ionic size of the metal ion. They may comprise a metal oxide. They may be particles consisting of a metal oxide or the metal oxide may form on the surface of a metallic regions. They may comprise a metal salt, i.e., they may comprise metal halides, carbonates, nitrates, phosphates, sulfates, sulfides or they may comprise any other suitable anionic counterion species. The metal salts may be insoluble in water, or they may be partially soluble in water, or they may be highly soluble in water. They may have a mean particle size of about 1 to about 20 nm, or about 2 to 10, 2 to 5, 5 to 20, 10 to 20 or 5 to 20, e.g., about 2, 3, 4, 5, 6, 7, 8, 9, 10, 11, 12, 13, 14, 15, 16, 17, 18, 19 or 20 nm. They may have the same mean particle size as the hydrophobic particulate solid or they may have a different mean particle size.

The metal-containing particulate solid may provide antimicrobial or antibacterial activity to the coating by releasing metal ions or organometallic substances when wet, for example they may release Zn⁺, Cu²⁺, Ag⁺, Au⁺, Co²⁺ or Ni²⁺ ions or complexes thereof. The metal ions may then form their hydrated ions in aqueous solution. They may release metal-containing compounds, or form metal-containing compounds in solution with antimicrobial activity, for example they may release or form oxides, carbonates, amines or chlorides in solution. They may photocatalyze water and/or oxygen to generate reactive oxygen species (ROS) such as hydrogen peroxide (H₂O₂), superoxide (⁻O₂⁻), hydroxyl radical (⁻OH) or singlet oxygen. The metal-containing species and/or ROS may kill the bacteria upon contact and absorption by the bacteria, or they may paralyse or prevent bacteria from reproducing. The metal-containing particulate solid may be hydrophilic or it may be hydrophobic.

The antimicrobial coating of the present invention displays a superhydrophobic surface. The “surface layer” may be the top 20% of the coating, or the top 15% of the coating, or the top 10%, or the top 5%, or the top 2%. The surface layer may comprise the IPN and the hydrophobic particulate solid, or the surface layer may comprise the IPN, the hydrophobic particulate solid and the metal-containing particulate solid. The hydrophobic particulate solid may be at least partially embedded in the IPN in the surface layer or it may be completely embedded in the IPN in the surface layer. The metal-containing particulate solid may be at least partially embedded in the IPN in the surface layer or it may be completely embedded in the IPN in the surface layer or it may be completely embedded in the IPN whereby the surface layer is substantially free of metal-containing particulate solid. By superhydrophobic, it is meant that the water contact angle of the coating is greater than 150°, e.g., it may be about 150°, or about 155°, 160°, 165°, 170° or about 175°. It may exhibit Cassie-Baxter wetting characteristics. It may have a lotus-leaf effect. It may be self-cleaning. By self-cleaning, it is meant that the rolling angle is less than about 10°, e.g., it may be about 10°, 9°, 8°, 7°, 6°, 5°, 4°, 3°, 2°, 1° or 0°. In one embodiment, the rolling angle is about 0°. The antimicrobial coating may be capable of maintaining these superhydrophobic characteristics after at least 50 abrasion cycles, or after at least 75, 100, 125, 150, 175, 200, 225, 250, 275 or 300 abrasion cycles. The water contact angle and/or rolling angle may vary by no more that 5% (i.e., it may vary by about 5%, or about 4%, 3%, 2%, 1% or not at all) after 100 abrasion cycles, or after 150, 200, 250 or 300 abrasion cycles.

The antimicrobial coating of the present invention comprises both a hydrophobic particulate solid and a metal-containing particulate solid. The percentage by mass of the metal-containing particulate solid to the hydrophobic particulate solid may be between about 5% to about 20% (e.g., the total particulate solids may be about 5, 6, 7, 8, 9, 10, 11, 12, 13, 14, 15, 16, 17, 18, 19 or 20% metal-containing particulate solid and the balance to 100% being hydrophobic particulate solid). Put differently, the mass ratio of the metal-containing particulate solid to the hydrophobic particulate solid may be between about 1:20 and about 1:5 (e.g., it may be about 1:20, 1:15, 1:10, 1:6.67 or 1:5 of metal-containing particulate solid to hydrophobic particulate solid). In one preferred embodiment, the coating comprises particulate solid in the proportion by mass of 15% metal-containing particulate solid and 85% hydrophobic particulate solid (i.e., a mass ratio of about 1:6.67).

As well as being superhydrophobic, the coating of the present invention is antimicrobial. It may be active against bacteria, viruses, fungi, algae or other microorganisms. It may be active against a broad spectrum of bacteria, including both gram-positive and gram-negative bacteria. It may be active against pathogenic bacteria. By active, it is meant that it may eliminate cells of microorganisms or it may repress reproduction by cells of microorganisms or it may resist adherence of the bacteria to the surface to form colonies. It is understood that antimicrobial activity may be asserted at the surface of the coating via more than one process, i.e., it may resist adhesion of the bacteria to the surface by plastron formation at the surface-liquid interface, or it may eliminate bacteria in the vicinity of the surface by releasing active antimicrobial agents, such as metal ions or producing reactive oxygen species. When the dry surface of the coating is contacted with a water-based liquid, such as a bacterial suspension, a plastron forms due to establishment of a Cassie-Baxter wetting state. This plastron is a thin layer of air that physically separates the water, and any bacteria therein, from the coating surface. When formed, this plastron may be maintained by the surface for at least 2 hours up to about 24 hours (i.e., the plastron may be maintained for about 2, 3, 4, 5, 6, 7, 8, 9, 10, 11, 12, 13, 14, 15, 16, 17, 18, 19, 20, 21, 22, 23 or 24 hours) under atmospheric pressure and at temperatures between a room temperature and a bacterial incubation temperature 37° C. (i.e., between about 20, 21, 22, 23, 24, 25, 26, 27, 28, 29, 30, 31, 32, 33, 34, 35, 36 or 37° C.) and at a submersion depth ranging from partial submersion (e.g., a drop or droplets on the surface of the coating) to complete submersion up to about 5 cms in depth (i.e., about 1, 2, 3, 4 or 5 cms of water extending above the coating surface). The amount of time that the plastron is maintained by the surface is inversely related to the depth of submersion. For instance, the plastron may be maintained by the surface for at least 8 hours or more at a submersion depth of 2.5 cm, whereas the plastron may be removed earlier than 8 hours after submersion at a depth of 5 cms. Likewise, the plastron may be maintained for 24 hours or more if only partially submerged or submerged at a lesser depth (e.g., 1 cm).

Both antimicrobial processes (i.e., plastron-based separation and broadly active chemical antimicrobial activity) may occur at distinct regions of the coating simultaneously, e.g., bacteria may be prevented from adhesion at portions of the surface maintaining a plastron layer, and may produce active antimicrobial agents at a portion of the surface that has been wetted by the bacterial suspension following plastron bursting. The coating may eliminate or prevent formation of a biofilm if bacterial adhesion is eliminated, whereby a biofilm is understood to be a consortium of microorganisms embedded within a slimy extracellular matrix formed from exuded extracellular polymeric substances (EPS). Prevention of biofilm formation is important in many situations, as biofilm removal or disruption is generally difficult, due to the chemical and physical resistance of the EPS in the biofilm.

The coating described herein may resist bacterial adhesion or colonization when in contact with a bacteria-containing liquid, whereby colonization by bacteria is defined as the adherence of bacteria to, and reproduction upon, a surface of the coating of the present invention. It may resist bacterial adhesion or colonization when in constant contact to a bacteria-containing liquid for hours (e.g., about 1, 2, 3, 4, 5, 6, 7, 8, 9, 10, 12, 14, 16, 18, 20, 22 or 24 hours) or days (e.g., about 1, 2, 3, 4, 5, 6 or 7 days) or weeks (e.g., about 1, 2, 3 or 4 weeks). It may resist bacterial adhesion or colonization of both gram-positive bacteria and gram-negative bacteria. It may resist pathogenic bacteria. For example, it may resist or prevent adhesion of Escherichia sp. (such as E. coli), Staphylococcus sp. (such as S. aureus), Bacillus sp. (such as B. cereus), Campylobacter sp. (such as C. jejuni), Clostridium sp. (such as C. difficile or C. perfringens), Listeria sp. (such as L. monocytogenes), Salmonella sp. (such as S. typhi) or Pseudomonas sp. (such as P. aeruginosa). In one embodiment, it may resist bacterial adherence or colonization when in constant contact with a bacterial suspension containing between 104-105 CFU/ml, for at least 9 days (i.e., for about 9, 10, 11, 12, 13 or 14 days, or for about 2, 3 or 4 weeks, or more).

### Method

Methods for making the antimicrobial coating of the present invention initially comprises the step of applying an IPN to a surface to be coated (i.e., the surface upon which the coating is to be formed). The IPN is applied to a surface by applying colloidal IPN particles to the surface. This may comprise forming or obtaining colloidal IPN particles that are to be applied to a surface. The colloidal particles may be formed by any suitable method. An example of a suitable method is described in WO 2017/193157 A1, although any suitable method may be used to produce colloidal IPN particles. In the methods described below, the colloidal IPN particles, the hydrophobic particulate solid and metal-containing particulate solid are as described above, including all variations described thereof.

The colloidal IPN particles comprise, or contain, or essentially contain, a polymer system based on urethane monomers (that is, a polyurethane), and a polymer system based on acrylic or methacrylic monomers (that is, a polyacrylate or polymethacrylate), which are at least partially interlaced. In one preferred embodiment, the polyacrylic polymer system is polymethyl methacrylate (PMMA) interlaced with polyurethane (PU). The colloidal IPN particles may be suspended in an organic solvent and applied to a surface to be coated. The organic solvent may be any suitable organic solvent. The organic solvent preferably is volatile and quickly evaporates from the coated surface following application of the colloidal IPN particles to the surface. The organic solvent may be a mixture of miscible organic solvents. An example of suitable solvents are acetone, xylene, toluene and alcohols although other solvents may be used. By alcohols, it is meant that any linear, branched, cyclic or aromatic alcohol with suitable volatility may be used. For example, the alcohol may be a primary alcohol, for example methanol, ethanol, propanol, butanol, pentanol, cyclobutanol, cyclopentanol, cyclohexanol, phenol, benzyl alcohol and the like; or it may be a secondary alcohol, for example 2-propanol, 2-butanol, 2-pentanol, 3-pentanol, 1-phenylethanol, 1-cyclobutyethanol, 1-cyclopentyethanol and the like; or it may be a tertiary alcohol, for example 2-methylpropan-2-ol, 2-methylbutan-2-ol, 2-methylpentan-2-ol, 3-methylpentan-3-ol, 2-cyclobutyl-2-propanol, 2-cyclopentyl-2-propanol, 2-phenyl-2-propanol and the like). The organic solvents disclosed herein may be anhydrous or they may contain some water. Applying the colloidal IPN particles to a surface may be carried out by dipcoating, spincoating, dropcasting, electrospinning, spraying, or any other suitable technique for applying a dispersion to a surface. The suspension of colloidal IPN particles may be a sprayable dispersion (i.e., may be suitable to be applied to the surface by spraying). The method and/or conditions for applying the colloidal IPN particles to a surface may be dependent on the material from which the surface is formed. The applying of the IPN particles to a surface produces a coated surface which, once cured, comprises a surface with micro-scale roughness.

In a preferred embodiment, the colloidal IPN particles are applied by spraying. The inventors have found that particularly preferable conditions include spraying the suspended colloidal IPN onto the substrate using an artist's acrylic spray gun of 0.3 mm diameter, whereby the nozzle of the spray gun is at a distance of about 15 cms above the surface of the substrate and at about 45° relative to the surface of the substrate. The spraying is conducted at a rate of 5 mL per 4 cm².

A metal-containing particulate solid as described herein may optionally be incorporated into the IPN layer. The metal-containing particulate solid may be incorporated into the colloidal IPN particles (i.e., added to the process to form the colloidal IPN particles), or they may be suspended alongside the colloidal IPN particles as a mixture (i.e., added after the colloidal IPN particles are formed). The metal-containing particulate solid is then applied to the surface with the colloidal IPN particles when forming a coated surface. Presence of a metal-containing particulate solid in the IPN layer does not preclude the addition of a further metal-containing particulate solid layer applied to the coated surface. Put differently, in some embodiments the antimicrobial coating may comprise a metal-containing particulate solid present in the IPN layer and a metal-containing particulate solid layer partially embedded in the surface layer of the coating. These metal-containing particulate solids may comprise the same metal or metal species or they may comprise different metals or metal species.

Likewise, a hydrophobic particulate solid as described herein may optionally be incorporated into the IPN layer. The hydrophobic particulate solid may be incorporated into the colloidal IPN particles (i.e., added to the process to form the colloidal IPN particles), or they may be suspended alongside the colloidal IPN particles as a mixture (i.e., added after the colloidal IPN particles are formed). The hydrophobic particulate solid is then applied to the surface with the colloidal IPN particles when forming a coated surface. Presence of a hydrophobic particulate solid in the IPN layer does not preclude the addition of a further hydrophobic particulate solid layer applied to the coated surface. Put differently, in some embodiments the antimicrobial coating may comprise a hydrophobic particulate solid present in the IPN layer and a hydrophobic particulate solid layer partially embedded in the surface layer of the coating.

Moreover, both a metal-containing particulate solid and a hydrophobic particulate solid as described herein may both be optionally incorporated into the IPN layer. A mixture of a metal-containing particulate solid and a hydrophobic particulate solid may be incorporated into the colloidal IPN particles (i.e., added to the process to form the colloidal IPN particles), or the mixture may be suspended alongside the colloidal IPN particles as a mixture (i.e., added after the colloidal IPN particles are formed), or they may be incorporated separately (for example, one of a metal-containing particulate solid or a hydrophobic particulate solid may be incorporated into the colloidal IPN particles, and the other particle type be suspended alongside the colloidal IPN particles). Both the metal-containing particulate solid and the hydrophobic particulate solid is then applied to the surface along with the colloidal IPN particles when forming a coated surface. Presence of a metal-containing particulate solid and a hydrophobic particulate solid in the IPN layer does not preclude the addition of a further metal-containing particulate solid layer or a further hydrophobic particulate solid layer applied to the coated surface. Put differently, in some embodiments the antimicrobial coating may comprise a metal-containing particulate solid and a hydrophobic particulate solid present in the IPN layer and a surface layer comprising a partially embedded metal-containing particulate solid and/or a hydrophobic particulate solid. The metal-containing particulate solids within and/or upon the coating may comprise the same metal or metal species or they may comprise different metals.

The hydrophobic particulate solid described herein is then applied to the coated surface following application of the colloidal IPN particles to the surface. The hydrophobic particulate solid may be applied almost immediately after application of the colloidal IPN particles, or the coated surface may be allowed to partially dry or cure before applying the hydrophobic particulate solid. The drying or curing may be conducted at any suitable temperature, which will commonly be at ambient temperature (e.g., between about 20° C. and 25° C.). The hydrophobic particulate solid may be applied as dry particles or they may be suspended in an organic solvent. They may be applied by spraying. Preferably, the hydrophobic particles are applied to the coated surface in order to provide a substantially even or uniform coverage (i.e., the density of hydrophobic particles are relatively the same at all points on the coated surface). The organic solvent may be any suitable organic solvent. It may the same solvent used to suspend the colloidal particles or it may be a different organic solvent. It may be miscible with the solvent used to suspend the colloidal particles or it may be immiscible. The organic solvent may be a mixture of miscible organic solvents.

The metal-containing particulate solid described herein may be applied to the IPN coated surface. They may be applied as dry particles or they may be suspended in an organic solvent. They may be applied by spraying. The organic solvent may be any suitable organic solvent. It may the same solvent used to suspend the colloidal particles and the hydrophobic particulate solid or it may be a different organic solvent. It may be miscible with the solvent used to suspend the colloidal particles and/or the hydrophobic particulate solid or it may be immiscible. The organic solvent may be a mixture of miscible organic solvents. In one embodiment, the step of applying the metal-containing particulate solid to the coated surface may be conducted soon after application of the hydrophobic particulate solid has been conducted. Application of both the hydrophobic particulate solid and metal-containing particulate solid may be conducted in series before the coated surface has completely cured or dried (e.g., whilst the coated surface has only partially cured or dried). Preferably, when applied after the hydrophobic particulate solid, the metal-containing particulate solid is also applied to the coated surface in order to provide a substantially even or uniform coverage of metal-continuing particles (i.e., the density of metal-containing particles is relatively the same at all points on the coated surface). In an alternative embodiment, the steps of applying the hydrophobic particulate solid and the metal-containing particulate solid may occur simultaneously (i.e., at substantially the same time). Simultaneous application of both particulate solids may be conducted by applying each particulate solid separately or by pre-mixing the hydrophobic particulate solid and the metal-containing particulate solid together before application. When mixed, the particulate solids are preferably substantially homogenous, to ensure an even or uniform coating of both particles when applied to the coated surface.

In another embodiment, the antimicrobial coating of the present invention may comprise the addition of the metal-containing particulate solid to the colloidal IPN particle suspension and applied simultaneously with the IPN coating to a surface, to which the hydrophobic particulate solid is then applied. In other words, in this embodiment the metal-containing particulate solid is applied simultaneously with the colloidal IPN particles and is hence completely embedded within, or intrinsic to, the IPN layer when applied. The hydrophobic particulate solid is then applied to the surface coated with the colloidal IPN particles and metal-containing particulate solid.

In this embodiment, the initial step of the method is conducted by applying a suspension mixture to the surface, whereby the suspension mixture comprises a suspension of colloidal IPN particles and a metal-containing particulate solid. The suspension mixture may comprise a mixture of these particles in suspension in an organic solvent. The organic solvent may be acetone or may be any other suitable organic solvent. The organic solvent may be a mixture of miscible organic solvents. The suspension mixture may be substantially homogenous with respect to the distribution of metal-containing particles to colloidal IPN particles before applying to the surface. Substantial homogeneity may be achieved by shaking the suspension mixture immediately before applying, if required (e.g., if one or both of the colloidal IPN particulate solid or metal-containing particulate solid settles or falls out of suspension), or it may be a suspension capable of maintaining both colloidal IPN particles and metal-containing particles in suspension over a substantial period of time (i.e., about 1, 2, 3, 4, 5 6, or 7 days or more) at ambient conditions (i.e., usually at a temperature of between about 20° C. to about 25° C., but may be between about 10° C. and about 35° C.). The percentage by mass of metal-containing particulate solid to hydrophobic particulate solid in the suspension mixture may be between about 0.1% and about 5% (i.e., it may be between about 0.1% and 2%, 0.2% and 3%, 0.25% and 2.5%, 0.5% and 4%, 1% and 5%, e.g., it may be about 0.1, 0.2, 0.3, 0.4, 0.5, 0.6, 0.7, 0.8, 0.9, 1, 1.5, 2, 2.5, 3, 3.5, 4, 4.5 or 5%). That is, the mass ratio of metal-containing particulate solid to hydrophobic particulate solid in the suspension mixture may be between about 1:1000 and about 1:20 (e.g., it may be about 1:1000, 1:900, 1:800, 1:700, 1:600, 1:500, 1:400, 1:300, 1:250, 1:200, 1:150, 1:100, 1:50, 1:40, 1:30, 1:25 and 1:20).

In this embodiment, the hydrophobic particulate solid described herein is then applied to the coated surface following application of the suspension mixture (comprising colloidal IPN particles and a metal-containing particulate solid) to the surface. The hydrophobic particulate solid may be applied almost immediately after application of the colloidal IPN particles, or the coated surface may be allowed to partially dry or cure before applying the hydrophobic particulate solid. The drying or curing may be conducted at any suitable temperature, which will commonly be at ambient temperature (e.g., between about 20° C. and 25° C.). The hydrophobic particulate solid may be applied as dry particles or they may be suspended in an organic solvent. They may be applied by spraying. Preferably, the hydrophobic particles are applied to the coated surface in order to provide a substantially even or uniform coverage (i.e., the density of hydrophobic particles are relatively the same at all points on the coated surface). The organic solvent may be any suitable organic solvent. It may the same solvent used to suspend the colloidal particles or it may be a different organic solvent. It may be miscible with the solvent used to suspend the colloidal particles or it may be immiscible. The organic solvent may be a mixture of miscible organic solvents.

The superhydrophobic films of the present invention may be used in any application in which superhydrophobicity and antimicrobial activity is a benefit and/or where abrasion resistance and/or durability is a benefit. For example, they may be used to reduce drag coefficient in water craft, or to reduce marine fouling, or to reduce corrosion of bodies, especially metallic bodies, immersed in water. They may also be used to reduce biofilm formation and provide easier cleaning of surfaces in medical settings (e.g., in hospitals, such as operating theatres, surgical suites, recovery and general wards, or pathology laboratories, or in general consulting suites), food preparation areas and bathrooms. They may also be used as coatings on electronics, solar panels, on glass surfaces to reduce droplet adhesion (e.g. for windscreens), in medical equipment, for rendering surfaces self-cleaning. They may also be used as a feedwater-facing coating on membranes used in reverse osmosis, ultrafiltration, microfiltration, membrane diffusion or any other membrane-separation technique utilizing a polymeric membrane or ceramic membrane or metallic membrane. They may be suitable for use in other applications. The surface may be any suitable surface to which the dried or cured coating adheres to. It may be a porous surface or it may be a non-porous surface. The surface may comprise or consist of plastic, concrete, glass, ceramic, wood or a mixture of these surfaces. Preferably, to assist in adherence of the coating to the surface, the surface should be clean before applying the colloidal IPN particles. In some embodiments, the surface may be pre-treated before the step of applying the colloidal IPN coating. The pre-treating step may include applying an organic solvent to the surface. The organic solvent may be the same as the organic solvent in which the colloidal IPN particles are suspended, and/or the hydrophobic particulate solid, and/or the metal-containing particulate solid, or it may be different.

A coating on the surface may be produced by conducting either of the methods described above on the surface and allowing the resulting cure to cure or dry. It is understood that this requires the organic solvent in which at least the colloidal IPN particles are suspended to be completely or substantially removed from the coating (e.g., greater than about 95%, or about 96%, or about 97%, or about 98% or about 99% or about 100% removed from the coating).

The coatings described herein, or produced by the methods described herein, may be used as a protective coating. A protective coating is capable of reducing damage to the surface upon which the coating is applied (i.e., less damage occurs to a coated surface compared to an equivalent uncoated surface). The damage being reduced may be due to water contact, impact (e.g., with either a sharp implement or a blunt implement), chemical contact (e.g., acids, bases, organic solvents, or oxidants) or abrasion.

The coatings described herein, or produced by the methods described herein, may render the surface both superhydrophobic and antimicrobial.

In a particular embodiment, the invention relates to a stable PU-PMMA colloidal IPN system that self-assembles during spray deposition into a hierarchically structured ultra-robust coating. This IPN coating serves as a platform for superhydrophobic nanostructures formed by application of hydrophobic particulate solids to the surface layer, enabling preservation of a highly dewetting Cassie-Baxter state. These superhydrophobic coatings preserved a pristine lotus-dewetting surface (WCA >150°, SA <10°) after at least 100 rotary abrasion cycles. The IPN coating also serves as a platform for metal-based antimicrobial particles which provide antimicrobial activity when the Cassie-Baxter wetting state is lost and the coating surface is wetted.

### EXAMPLES

### Discussion

### General Anti-Microbial Activity of Superhydrophobic Coatings

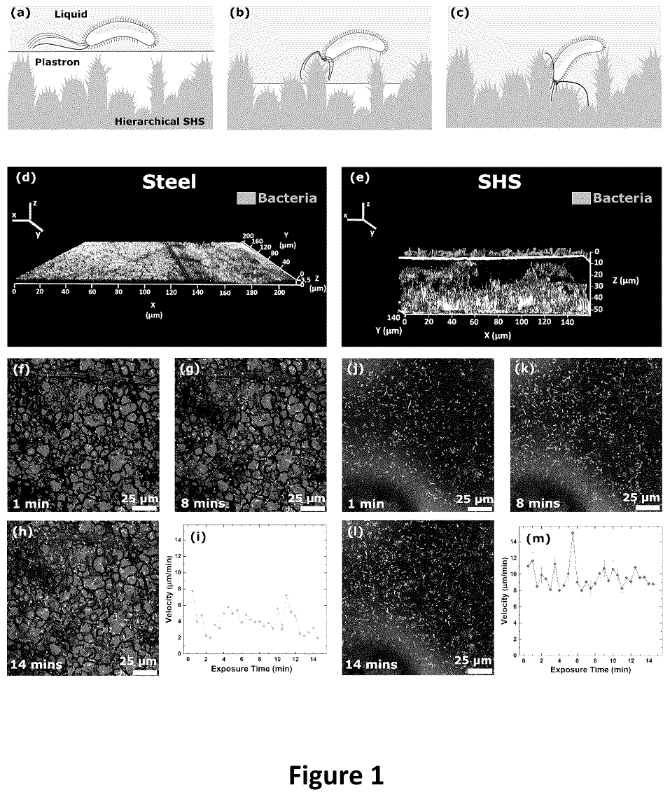

Superhydrophobic coatings have been previously demonstrated for resisting biofilm formation. The inventors have explored and visualised the mechanism behind this resistance and the characteristic surface interactions of the bacteria on coated vs non-coated surfaces. A schematic representation of the mechanism believed to provide resistance to bacterial colonisation on a superhydrophobic surface exposed to a bacterial suspension is shown in FIG. 1(a-c), whereby a plastron, or air-pocket, forms at the superhydrophobic surface, physically separating bacteria from the surface. It is understood that if bacteria can be prevented from attaching to a surface, a biofilm will not form on that surface.

To demonstrate this effect, a durable superhydrophobic coating as previously described by the inventors (WO 2017/193157 A1) was applied to a stainless steel surface. This superhydrophobic surface (SHS) coating consists of an interpenetrating polymer network (IPN) system applied to the steel surface, with superhydrophobic fused silica particles applied to the IPN coated surface. A second bare stainless steel surface was used as a control. A droplet of bacterial suspension (gram-negative Escherichia coli and gram-positive Staphylococcus aureus) in its exponential growth phase was anchored to each surface and observed. It was seen that bacteria immediately settle on the steel surface, whereas for the superhydrophobic coated surface, bacteria in the suspension floats above the plastron, repelled by surface tension from the surface. The plastron can be seen anchored by the highest rough protrusions and this leaves discreet nano-micron scale regions of the solid surface exposed to the bacteria. FIG. 1(e) demonstrates this anti-biofouling effect of the superhydrophobic coated surface relative to the bare steel sample FIG. 1(d).

The movement of the bacteria were also observed for both the coated and uncoated surfaces. It was observed that bacteria immediately settle on the steel surface, whereas, in case of SHS, bacteria in the suspension floats above the plastron. The plastron can be seen anchored by the highest rough protrusions and this leaves discreet nano-micron scale regions of the solid surface exposed to the bacteria. To further understand the interaction of the bacteria, a droplet of bacterial-suspension was anchored to one location on each of the surfaces and the cell behaviour was recorded for 15 minutes. Bacterium possesses hair-like structures on their cell wall called flagellum which aids them in exploring potential hummocks and nutrition followed by attaching to a surface. On the steel surface, the cells attach using their flagellum and display nanoscopic vibrations around their equilibrium positions, which is characteristic of a surface-bound motility behaviour called swarming. Swarming and the process of biofilm formation is an antagonist to each other in the sense that biofilms are sessile colonies whereas swarming involves motion. Depending on the availability of nutrition and other factors, bacteria would choose to permanently attach and form biofilms or keep swarming on the surface. In comparison to the steel surface, the behaviour of cells on the SHS is different. Here, the bacteria seem to swim in a ‘collective motion’ within the droplet of suspension, without being able to attach to the actual solid surface as the plastron masks the surface from the cells. Images taken at specific time points for the uncoated steel are shown in FIG. 1(f-h) and for the coated steel surface is shown in FIG. 1(j-l). Attaching bacteria are false coloured to yellow. Velocity profiles of cells on both the surfaces numerically displays this difference in the interactions at different points in time (FIG. 1(i, m)). Cells on the steel have significantly lower values of average velocity and record higher values of standard error compared to that on SHS. Biofilm formation on an abiotic (here, the uncoated surface) surface starts with a primary adhesion stage and this stage is greatly influenced by hydrophobic interactions between the cell and the surface, whereas the SHS prevents the initial primary stage of adhesion due to its superhydrophobicity.

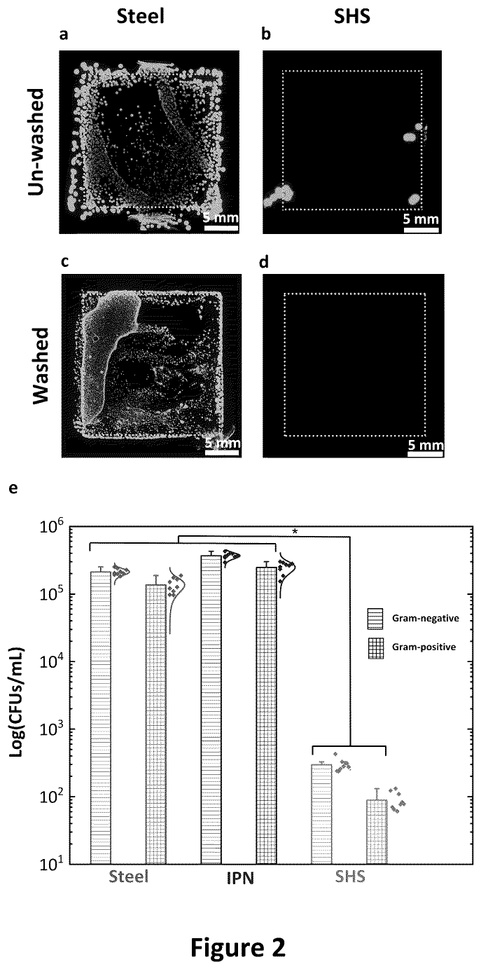

The inventors performed an evaluation of the extent of surface attachment of bacteria on the SHS coated steel relative to the non-coated steel surface. Qualitative adhesion of bacteria by stamping bacteria-challenged surfaces on the agar plates, and the effects of washing on those challenged surfaces, provides a visual demonstration of bacterial adhesion to surfaces. Both coated steel and uncoated steel surfaces were challenged by a bacterial suspension in its exponential growth phase for 10 minutes. In the ‘un-washed’ analysis (whereby the challenged surfaces are not washed prior to agar stamping), the agar plates stamped with the control specimens shows a square-shaped layer of bacterial colonies formed that were impossible to quantify considering their density (FIG. 2(a)). It was therefore assumed complete colonisation of the uncoated surfaces. In contrast to this, agar plates corresponding to the SHS shows only a few colonies (≤11) (FIG. 2(b)). In the ‘washed’ analysis (whereby the challenged surfaces were gently cleaned by submersion in a PBS solution and gently vortexed for 3 seconds), similar results were obtained for the control (i.e., uncoated) specimens (FIG. 2(c)), but there was no evidence of any bacterial colonies for the SHS (FIG. 2(d)).

In the un-washed sample where a small number of colonies were evident on the SHS (FIG. 2(b)), it is believed that this is due to loosely adhered bacteria, but none in case of the washed analysis as they are completely removed by a gentle wash in PBS (FIG. 2(d)). This could occur due to colonization on the micron scale defects within the coating, where the fluorosilica particles did not deposit initially during the spraying. Bacteria could also get attached to the dust particles that were originally floating on the plastron, which may be transferred during stamping on the agar plate, resulting in the colony formation. In the case of the washed analysis, any retained bacteria on the SHS was washed off by the motion of the fluid around it. The washed SHS retained statistically zero bacteria on it, which proves its superior self-cleaning and antibacterial nature. Notably, the comparison between the washed and unwashed bare steel surfaces are indicative of biofilm formation, as the bacteria could not be removed by gentle washing.

The effect of the SHS coating is also evident from the serial dilution data as shown in FIG. 2(e). The micro-rough IPN surface (i.e., a polymer coating without superhydrophobic particles applied, therefore only exhibiting micrometre-scale roughness) provided more area for the bacteria to attach, hence shows higher values than the uncoated surface (FIG. 2(e)). The SHS relative to the uncoated surface was able to resist 99.99% of the bacteria from colonizing. Therefore, the superhydrophobic coated surfaces were able to resist bacteria colonisation when contacted for relatively short periods of time.

However, when such superhydrophobic coatings are submerged for extended periods of time, the liquid pressure above the plastron causes it to slowly degrade, beginning to expose the underlying solid coating surface that can now subsequently be colonised by the bacteria, before finally bursting.

### In-Situ Colonization at the Defect-Coating Interface

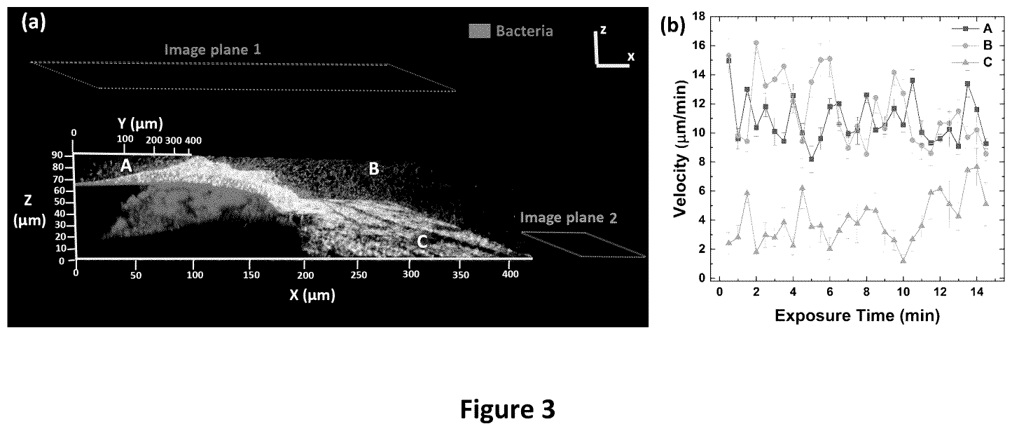

Coatings in use can be damaged, resulting in local loss of the superhydrophobic coating at defects. The effect of such defects on bacterial colonisation was measured. SHS-defect interface analysis was carried out using Confocal Laser Scanning Microscopy (CLSM). A defect was created on the SHS by scraping off the coating using a sharp-pointed knife. A droplet of bacterial suspension was anchored on the substrate in such a way that it covers the entire defective region and a fraction of the pristine undamaged regions. The interface between the defect and the SHS was imaged using CLSM to understand the behaviour of bacteria over time once a SHS sustain damage. FIG. 3(a) shows the orthogonal projection of the defect-coating interface. The plastron can be observed on the coated region A, where the bacteria is floating on top of it and it disappears at the interface. The defective region can be divided into two parts, B and C. Bacteria in Region A and B exhibit the usual swimming behaviour of bacteria (as discussed in paragraphs [00080]-[00086] above) whereas as in C, bacteria are coming in contact with the defect. The defective region has the superhydrophobic coating completely removed and hence has no defence against bacteria. Analysis of the velocity profiles in regions A, B and C is in agreement with our previous conclusions drawn from FIG. 1(i, m). A and B register similar velocities whereas C has much smaller and highly variable values indicating adhesion to the defect surface (FIG. 3(b). The presence of any micron-submicron defects would act as a colonization site for the bacteria, which could be what was observed by the inventors as some isolated colonies on the agar plates of the ‘unwashed’ SHS in FIG. 2(b). Since biofilms form a sessile protected form of growth on solid surfaces, it can be assumed that there is a migration of bacteria from regions A and B to region C. Scanning Electron Microscopy (SEM) analysis of a defective coating challenged with bacterial culture for 10 minutes was also performed. Bacteria had begun to colonise the defective area of the sample, whereas there was no evidence of bacteria attached to the non-defective regions of the sample.

### Plastron Stability

The inventors considered the stability of the plastron upon long-term liquid submersion. This was achieved by immersing the SHS in a liquid column of bacterial culture. Following this, they performed CLSM imaging of the plastron immersed in dye coloured Milli-Q water to understand the mechanism of plastron degradation. Specimens were immersed at a depth of 2.5 cm within the bacterial suspension for up to 8 hours.

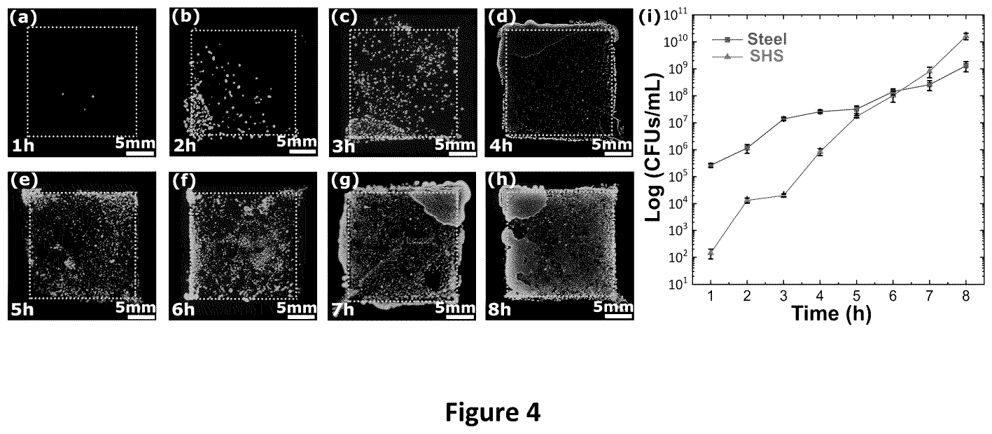

The images of the stamped imprints on the agar plates are shown in FIG. 4(a-h). Our SHS coating was able to retain the plastron for up to 2 hours without any significant colonization (FIG. 4(a, b)). For exposures of between 3 to 5 hours, the presence of an increasing number of colonies on the agar plates corresponding to the test specimen are observed (FIG. 4(c-e)). Beyond 5 hours, the entire surface was colonized indicating the complete removal of the plastron layer (FIG. 4(f-h)). Data on serial dilution shows it is in agreement with our observation regarding the stability of the plastron (FIG. 4(i)). The control samples also experience an increased adhesion of the bacteria with time. This is because bacteria adhering directly to a solid surface forms a layer that links all other bacteria growing on top of it to the solid surface.

These results are explained in terms of the metastability of the plastron when submerged in a liquid column for longer times. By leaving an SHS in a column of deionized water coloured with rhodamine B, it was observed that initially, the plastron is supported by the tallest rough structures. After a certain point of time (6 hours here), the plastron starts exhibiting a rapid disintegration and it gets isolated in the form of a bubble supported by the rough features. Subsequently, the bubble then begins to collapse leading to the wetting of the surface. The disintegration here is a function of the immersion depth and as it increases, the exponential changes in the partial vapour pressure of gases with the liquid pressure facilitate an exponential increase in diffusion of air into the liquid. It has to be noted that the lifetime of the plastron is also function of roughness and that there will be a variation in roughness over the area of the specimen. For this reason, the transition from non-wetting to wetting regimes does not occur abruptly and at the same time for the entire area of the coating. Another thing to be noted is that the presence of an active culture of bacteria and its dynamic nature can induce additional pressure on the plastron, decreasing its stability.

### Experimental

### Example 1—Improved Antimicrobial Coating

As shown in the above discussion, superhydrophobic surfaces act to resist microbial colonisation over periods of time of up to about 2-3 hours, by maintaining a plastron at the surface, stopping the bacteria from adhering to the surface. However, when superhydrophobic surfaces are in contact with aqueous solutions over extended periods of time, or a defect in the surface occurs through damage (as shown in paragraphs [00088]-[00090] above), the plastron can break down and the surface becomes wetted, allowing bacteria to adhere and form a biofilm. In many settings, for instance in hospitals, it is unlikely that the coating will be submerged for periods longer than 2 hours, although local damage with sharp implements may occur. Such instability does limit the breadth of applications for SHS, for instance, in marine environments, membrane systems, or bathrooms, where an antibiofouling surface that could tolerate extended submersion would be significant.

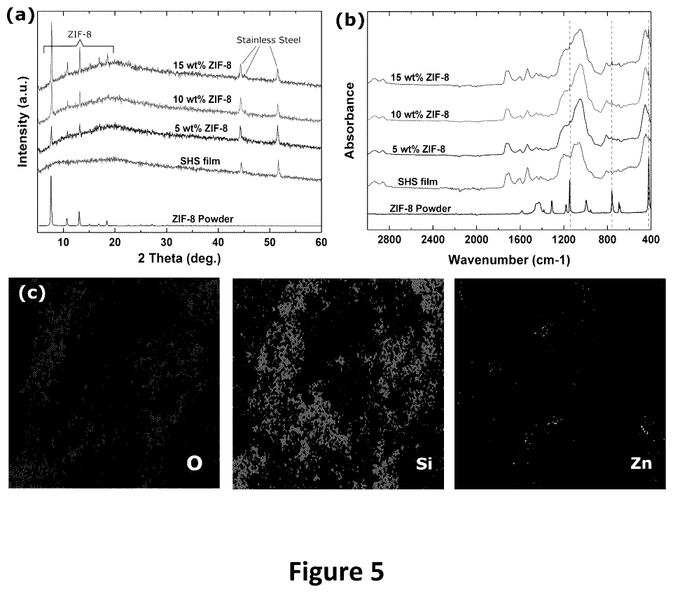

To this end, the inventors have exploited the antimicrobial and hydrophobic properties of coatings containing sub-micron ZIF-8 particles to impart dual functionality into the coatings. A superhydrophobic coating was prepared as described in the discussion above, but particles of the metal organic framework (MOF) material ZIF-8 were mixed with the fluorosilica particles at various relative weight percentages: 5% (Z5), 10% (Z10), 15% (Z15) and 20% (Z20) w/w compared to the fluorosilica particles. The ZIF-8 particles were manufactured using a previously reported method, i.e. the mechanochemical synthesis method previously reported by Taheri et al, to produce sub-micron particles (approximately 200-400 nm in size). The particle mixture was then suspended in acetone as the solvent and applied by spraying after the IPN suspension was applied onto steel substrates. Contact angle values for the cured coatings were measured and recorded as 161±4.67°, 158±1.41°, 155±0.66° and 149±1.63° for Z5, Z10, Z15 and Z20, respectively. The rolling angle was zero for all except Z20, which recorded close to 10°. Z20 was eliminated from further characterizations as the contact angle was less than 150°. XRD and FTIR spectroscopy characterisations also confirms the presence of ZIF-8 in the coating (FIGS. 5(a) and (b)). EDS elemental mapping of the coating shows the distribution of silicon, oxygen and zinc in the coating (FIG. 5(c-e) respectively).

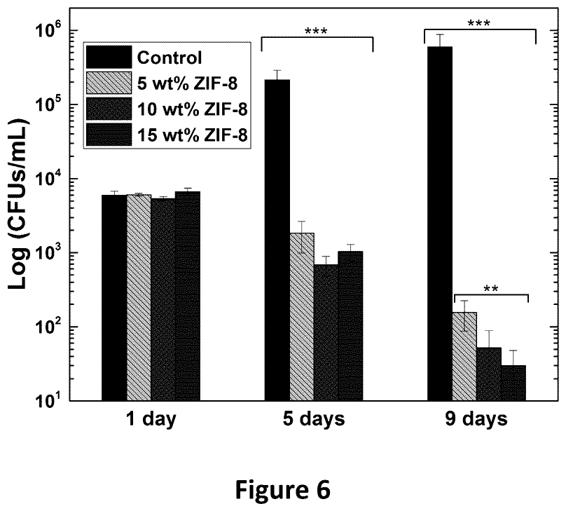

Once formed, the Z5, Z10 and Z15 coatings comprising ZIF-8 particles, as well as an uncoated steel sample as a control, were exposed to media containing bacteria in the order of 104-105 CFU/mL in a 5 cm column over long incubation times. After 1, 5 and 9 days, remaining bacteria in the suspension are quantified as shown in FIG. 6, whereby an uncoated steel surface is provided as a control. As can be seen from FIG. 6, after 1 day there was no statistical difference between the control and the test samples. After 5 days, the test samples with ZIF-8, i.e. Z5, Z10, Z15 shows a remarkable reduction in the cell counts, within similar limits of error. The control sample had an increase in cell counts. After 9 days, the difference between samples with ZIF-8 and the control is much more significant. Z15 shows the highest reduction among the test samples as expected due to the presence of higher amounts of zinc ions.

It is understood that the presence of ZIF-8 particles in the surface of the coating act as an additional antibacterial mechanism. Once the plastron has disappeared completely, which would be expected to occur after about 8 hours, gradual wetting of the coating causes the ZIF-8 particles to also become wetted and display an antimicrobial effect. The inventors expect that this effect is caused from rupturing of the ZIF-8 particles and subsequent release of Zn ions that kills the bacteria near the surface. Irrespective of the precise mechanism of action, such anti-bacterial action at the surface of the ZIF-8 containing material could effectively prevent the bacterial fouling in wet conditions seen in coatings without ZIF-8 particles (see paragraphs [00087]-[00090] above).

The inventors further evaluated this dual functionality in dry conditions by mimicking a possible damage to the superhydrophobicity in the form of a defect. In this scratch experiment, SHS and Z15 materials were deliberately scratched, in a manner similar to the defect discussion above. Followed by this, a droplet containing bacteria culture in log phase was left on the defect. The surface was washed with PBS and then incubated. After 24 hours, the samples were stamped on agar plates, then incubated and imaged. The non-coated steel showed a wide spread adhesion of bacteria. Pristine SHS, without any defect has no bacterial adhesion due to its superhydrophobic nature. On the other hand, SHS with defect has bacteria attached on the defective region. When ZIF-8 is present in the coating, no colony of the bacteria was observed despite the defect in the SHS. This validates that when the plastron was eliminated and moisture made contact with the surface of the coating this facilitated the antimicrobial activity of ZIF-8 particles. This either kills the adhering bacteria, or forces them to move into a dormant phase of growth, without multiplying. These cells could be removed during the washing of the surfaces after incubation. The results prove the effectiveness of the dual functionality imparted to our coating and it works both in dry as well as wet conditions, and that dual functionality was imparted with any influence to the superhydrophobic nature of the as formed coatings.

1. An antimicrobial coating comprising:
a polyurethane and a polyacrylate in an interpenetrating polymer network;
a hydrophobic particulate solid; and
a metal-containing particulate solid.

2. The antimicrobial coating according to claim 1, wherein the metal-containing particulate solid comprises at least one metal selected from the group consisting of zinc, copper, silver, cobalt, nickel, gold, zirconium, magnesium and molybdenum, or an oxide thereof, and/or a metal organic framework, wherein the metal organic framework is ZIF-8, ZIF-67, UiO-66, Ag-BTC, PCMOF 10, Cu-MOF-14 or Cu-MOF-891 or a combination thereof.

3-6 (canceled)

7. The antimicrobial coating according to claim 1, wherein the hydrophobic particulate solid is hydrophobic fumed silica or is perfluoroalkyl-functionalised particles.

8. (canceled)

9. The antimicrobial coating according to claim 1, wherein the hydrophobic particulate solid has a mean particle size of between 1 nm and 20 nm in diameter and the metal-containing particulate solid has a mean particle size of between 1 nm and 400 nm in diameter.

10. The antimicrobial coating according to claim 1, wherein the water contact angle of the coating is greater than 150°, and/or wherein the rolling angle is less than about 10°, or wherein the rolling angle is about 0°, and wherein the water contact angle is reduced and/or rolling angle are increased by no more than 5% after at least 100 abrasion cycles performed according to ASTM D4060-14.

11-13 (canceled)

14. The antimicrobial coating according to claim 1, wherein the hydrophobic particulate solid and/or the metal-containing particulate solid is at least partially embedded in the coating, or wherein the hydrophobic particulate solid and/or the metal-containing particulate solid are fully embedded in the coating.

15. (canceled)

16. The antimicrobial coating according to claim 1, wherein the percentage by mass of the metal-containing particulate solid compared to the hydrophobic particulate solid is between about 5% and about 20%.

17. The antimicrobial coating according to claim 1, wherein the coating resists bacterial adherence for at least 9 days when in contact with a 10⁴-10⁵ CFU/ml bacterial suspension.

18. The antimicrobial coating according to claim 1, wherein when in contact with an aqueous environment, a plastron is formed on a surface of the coating and is maintained for at least 8 hours at temperatures between 20° C. and 37° C. and at a depth of up to 5 cms.

19. A method for rendering a surface hydrophobic and antimicrobial, comprising forming a coating according to claim 1 on the surface.

20. A method for making an antimicrobial coating of claim 1, comprising the steps of:
(a) applying a colloidal suspension to a surface to produce a coated surface, wherein the colloidal suspension comprises colloidal particles suspended in an organic solvent, and wherein the colloidal particles comprise an interpenetrating polymer network, wherein the interpenetrating polymer network consists of a polyurethane and a polyacrylate;
(b) applying a hydrophobic particulate solid to the coated surface; and
(c) applying a metal-containing particulate solid to the coated surface.

21. The method according to claim 20, wherein steps (b) and (c) are carried out simultaneously by applying a mixture comprising the hydrophobic particulate solid and the metal-containing particulate solid to the coated surface.

22-23 (canceled)

24. A method for making an antimicrobial coating of claim 1, comprising the steps of:
(a) applying a suspension mixture to a surface to produce a coated surface, the mixture comprising:
(i) a colloidal suspension, wherein the colloidal suspension comprises colloidal particles, and wherein the colloidal particles comprise an interpenetrating polymer network, wherein the interpenetrating polymer network consists of a polyurethane and a polyacrylate; and
(ii) a metal-containing particulate solid;
wherein the colloidal suspension and the metal-containing particulate solid are suspended in an organic solvent; and
(b) applying a hydrophobic particulate solid to the coated surface.

25. The method according to claim 20, wherein the applying of step (a) is by dipcoating, spincoating, dropcasting, electrospinning or spraying and the applying of step (b) and step (c) are by spraying.

26-34 (canceled)

35. The method according to claim 20, wherein the surface consists of plastic, concrete, glass, ceramic, paper, brick, wood or a mixture thereof.

36-37 (canceled)

38. A coating produced by conducting the method of claim 20 and allowing the resulting coating to cure.

39-40 (canceled)

41. The method according to claim 24, wherein the applying of step (a) is by dipcoating, spincoating, dropcasting, electrospinning or spraying and the applying of step (b) and step (c) are by spraying.

42. The method according to claim 24, wherein the surface consists of plastic, concrete, glass, ceramic, paper, brick, wood or a mixture thereof.

43. A coating produced by conducting the method of claim 24 and allowing the resulting coating to cure.
